(19) United States
(12) Patent Application Publication
(10) Pub. No.: US 2010/0221060 A1
(43) Pub. Date: Sep. 2, 2010

(54) Pen featuring as a USB memory device

(75) Inventor: Hong-Chi Yu, Kaohsiung City (TW)

Correspondence Address: BACON & THOMAS, PLLC, 625 SLATERS LANE, FOURTH FLOOR, ALEXANDRIA, VA, 22314-1176, US

(73) Assignee: WALTON ADVANCED ENGINEERING INC., Kaohsiung City (TW)

(21) Appl. No.: 12/385,029

(22) Filed: Mar. 30, 2009

(30) Foreign Application Priority Data
Feb. 27, 2009 (TW) 098106325

(51) Int. Cl. B43K 29/00

(52) U.S. Cl. 401/195

(57) ABSTRACT

The present invention relates to a pen featuring as a USB memory device, which includes a penholder having an upper penholder and a lower penholder, in which the upper penholder has an accommodation room whose one end communicates with the outer periphery of the upper penholder, and the lower penholder is provided to house a pen body; a foldable connection plug housed in the accommodation room of the upper penholder and having a support seat, at least a first connection part, at least a second connection part, and metal contacts being compatible with a USB transmission interface; and a main body housed in the accommodation room of the upper penholder and having at least an electronic component.

### FIELD OF THE INVENTION

The present invention relates to a pen featuring as a USB memory device, and more particularly to one having writing function with portability, holding comfort, easy accommodation and adaptability to a memory device with foldable plug and USB interface.

### BACKGROUND OF THE INVENTION

Owing to the rapid development of information technology, digital electronic products have been widely spread into various life areas of all walks of life. The growing adoption of digital electronic products makes people no longer content with the available functionality as far as the expectation on digital electronic products is concerned, and the frequent use urges that people are eager to find relevant products with integrated purpose and highly efficient portability.

In general, pen is one of the daily tools normally used by people and owns remarkable portability. Regular pens we know normally serve for writing purpose only. As a result, if a pen with a digital data storage device could be available, it allows user not only to write but also to provide additional digital data storing capability, making that the pen with integrated functions highly enhances its convenience.

The applicant submitted Taiwan Patent Number M24864 previously, which intends to add a memory device in collaboration with a USB (Universal-Serial-Bus) connector for enhancing user's carry-on and operational convenience. Whereas, in the course of the paramount development of semiconductor process, the brilliant development of miniaturization package technology, such as COB (Chip-On-Board) package or MCP (Multi-Chip-Package) process, brings into play the NVM (Non-Volatile Memory) with significant size reduction and increases its density to extensively integrate it with and apply it to other products.

Therefore, a pen equipped with a memory device can be more practical in actual application.

### SUMMARY OF THE INVENTION

In accordance with a first aspect of the present invention, a pen featuring as a USB memory device is provided. Given the COB or MCP miniaturization package technology, the memory device is advantageous to have a compact size, and the technique of foldable connection plug is further adopted to house the connection plug and the memory in an accommodation room, so that the pen maintains its original writing function in conveniently carrying and holding with ease without increasing the outer diameter of the penholder.

In accordance with a second aspect of the present invention, a pen featuring as a USB memory device is provided. Given the COB or MCP miniaturization package technology, the memory device is advantageous to have a compact size, and the technique of foldable connection plug is further adopted to house the connection plug and the memory in an accommodation room, so that the memory device is easily accommodated and not easily lost.

In accordance with a third aspect of the present invention, a pen featuring as a USB memory device is provided. Given the COB or MCP miniaturization package technology, the memory device is advantageous to have compact size, and the technique of foldable connection plug is further adopted to house the connection plug and the memory in an accommodation room, so that the present invention maintains the writing function in conveniently carrying and holding with ease and serves as a memory device having a USB interface to enable the present invention to be multi-functional.

To achieve the foregoing aspects, the present invention employs the following technical means to ensure that the pen structure includes: a penholder, a foldable connection plug, and a main body; the penholder contains an upper penholder and a lower penholder, in which the upper penholder has an accommodation room therein, one end of the accommodation room communicates with an outer periphery of the upper penholder, at least a compression spring is disposed at the other end, the upper penholder has at least a spring member, and the lower penholder is provided to house the main body of the pen; the foldable connection plug is disposed in the accommodation room of the upper penholder and contains a support seat, at least a first connection part, at least a second connection part, and metal contacts being compatible with a USB transmission interface; the main body is disposed in the accommodation room of the upper penholder and contains at least an electronic component.

Alternatively, the aspects of the present invention can be achieved by the following means to ensure that the pen structure includes: a penholder, a foldable connection plug, and a main body; the penholder contains an upper penholder and a lower penholder, in which the upper penholder has an accommodation room therein, one end of the accommodation room communicates with an outer periphery of the upper penholder, and the lower penholder is provided to house the main body of the pen; the foldable connection plug is disposed in the accommodation room of the upper penholder and contains a support seat, at least a first connection part, at least a second connection part, and metal contacts being compatible with a USB transmission interface, the support seat has a recess, a movable seat is disposed on the recess, and the movable seat has a push part; the main body is housed in the accommodation room of the upper penholder and contains at least an electronic component.

In contrast to the conventional skill, the function and effect of the present invention lies in that the foldable characteristic of the foldable connection plug enables the plug to be housed in the accommodation room of the upper penholder so that the memory device is easily received without being lost easily and the original writing function of the pen in conveniently carrying and holding with ease can still be remained, making that the present invention is multi-functional.

### BRIEF DESCRIPTION OF THE DRAWINGS

FIG. 1 is an exploded view showing the parts in accordance with the first preferred embodiment of the present invention;

FIG. 2 is a plain view of the present invention;

FIG. 3 is an A-A sectional view in accordance with FIG. 2 of the present invention;

FIG. 4 is a B-B sectional view in accordance with FIG. 3 of the present invention;

FIG. 5 is a schematic view showing a memory module with a fastener in accordance with the present invention;

FIG. 6 is a schematic view showing the flow processes in accordance with the second preferred embodiment of the present invention;

FIG. 7 is an exploded view showing the parts in accordance with the second preferred embodiment of the present invention;

FIG. 8 is an exploded view showing the parts in accordance with the third preferred embodiment of the present invention;

FIG. 9 is a schematic view showing the flow processes in accordance with the third preferred embodiment of the present invention; and

FIG. 10 is an exploded view showing the parts in accordance with the fourth preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purpose of illustration and description only; it is not intended to be exhaustive or to be limited to the precise form disclosed.

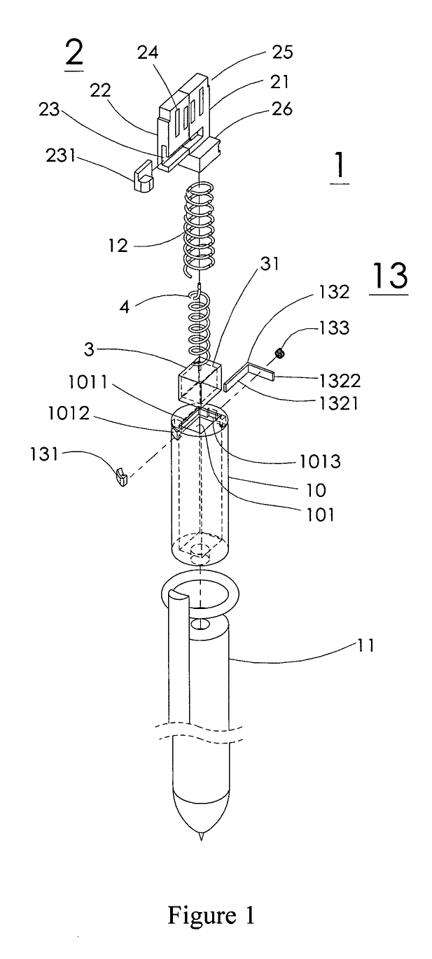

Please refer to FIG. 1, which shows a pen featuring as a USB memory device in accordance with the first embodiment of the present invention. The pen includes a penholder 1 having an upper penholder 10 and a lower penholder 11, in which the upper penholder 11 has a pen body, e.g. a refill case, and the upper penholder 10 and the lower penholder 11 can be detachably connected. The upper penholder 10 has an accommodation room 101 therein; one end of the accommodation room 101 communicates with an end of the upper penholder 10 and at least a compression spring 12 is disposed on the other end; at least a passageway 1011 is provided on one end of the accommodation room 101, one end of the passageway 1011 communicates with the outer periphery of the upper penholder 10 to form a notched hole 1012 and a cavity 1013 is disposed on the other end. Besides, the upper penholder 10 has at least a spring member 13 containing at least a press part 131, at least a push strip 132 and at least a compression spring 133, in which the push strip 132 has a first side end 1321 and a second side end 1322, the press part 131 is disposed on the outer periphery of the upper penholder 10 to correspond to the notched hole 1012, and the outer diameter of the upper penholder 10 is not greater than 12 mm.

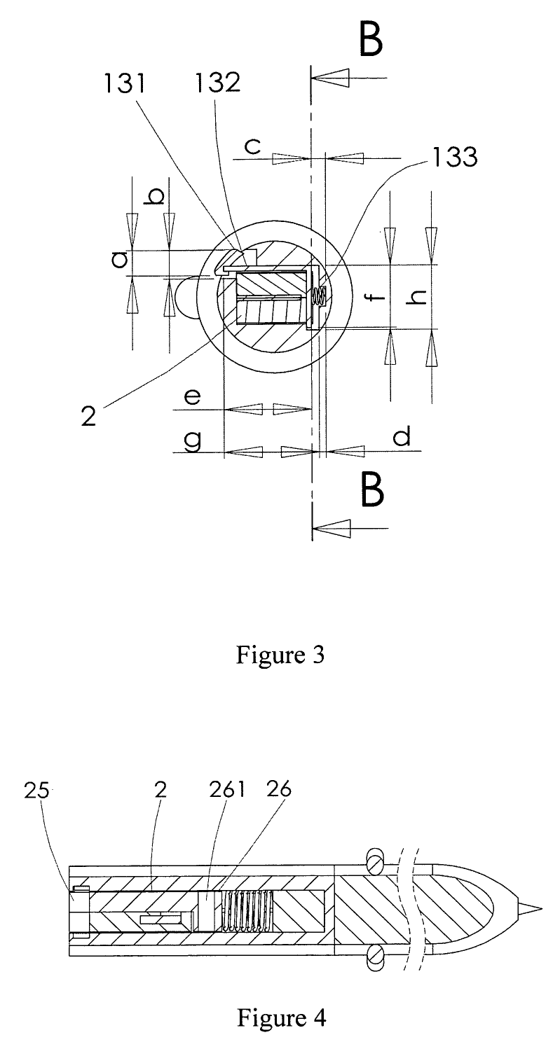

Please jointly refer to FIG. 1 and 3. The push strip 132 is housed in the passageway 1011 and the first side end 1321 of the push strip 132 is combined with the press part 131. The compression spring 133 is housed in the cavity 1013 of the passageway 1011 and is combined with the second side end 1322 of the push strip 132. When the foldable connection structure 2 is accommodated in the accommodation room 101 of the upper penholder 10, the height (c) of the compression spring 133 shall not be less than that (d) of the cavity 1013. The end-to-end length (a) of the outer periphery of the press part 131 shall not be greater than the end-to-end length (b) of the outer periphery of the notched hole 1012. Moreover, the end-to-end length (e+f) of the outer periphery of the push strip 132 shall not be greater than the end-to-end length (g+h) of the outer periphery of the passageway 1011.

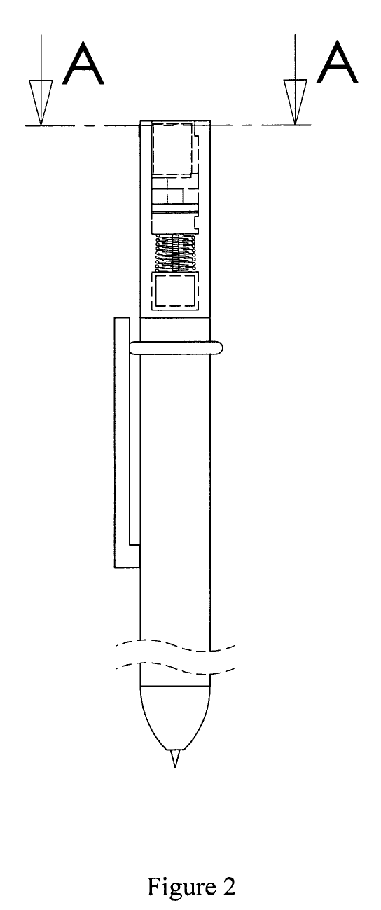

Please jointly refer to FIG. 2, 3, 4. The end face of the foldable connection plug 2 corresponding to the compression spring 133 has a first snap recess 25, and the end face of the support seat 26 opposite to the first snap recess 25 has a second snap recess 261.

Please jointly refer to FIG. 1, 3, 5. A foldable connection plug 2 is housed in an accommodation room 101 of the upper penholder 10. The foldable connection plug 2 includes the support seat 26, at least a first connection part 21, and at least a second connection part 22, in which the foldable connection plug 2 has metal contacts being compatible with a USB transmission interface, the metal contacts 24 are electrically connected with an electronic component being compatible with the USB transmission interface, and the electronic component which is compatible with the USB transmission interface can be an EDI (Electronic Data Interchange) device; and a main body 3 which is housed in the accommodation room 101 of the upper penholder 10 and contains at least an electronic component 31.

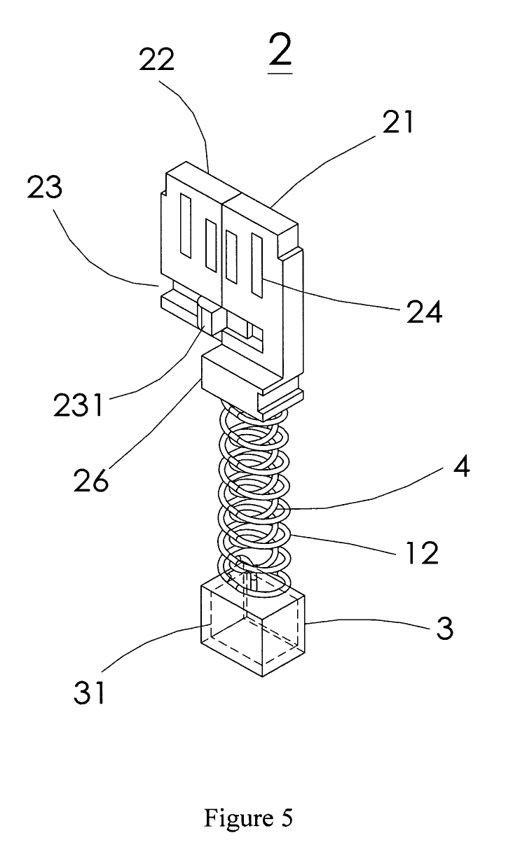

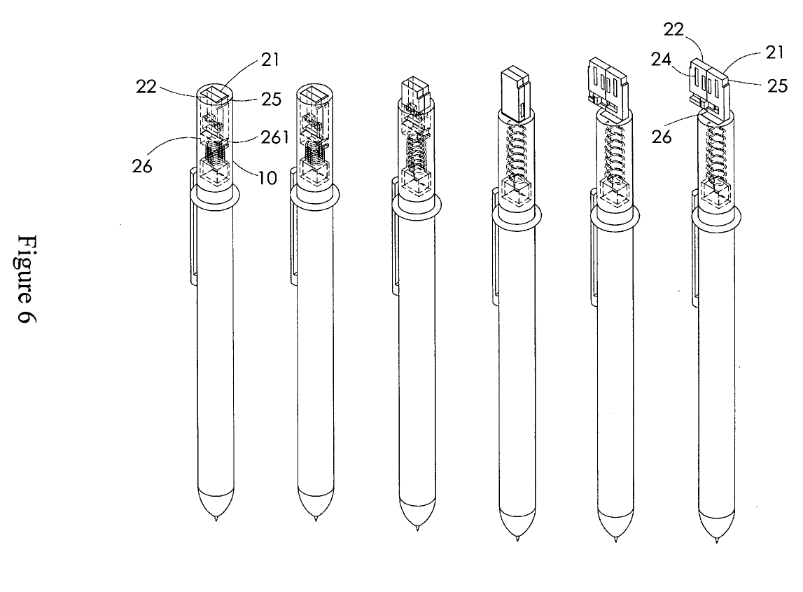

Please refer to FIG. 5. The foldable connection plug 2 has at least a track 23, in which the track 23 communicates with the opposite end faces of the first connection part 21 and the second connection part 22, and at least a fastener 231 is disposed on the track 23. The compression spring 12 is located between the support seat 26 and the main body 3. An electrical connection wire 4 is located between the support seat 26 and the main body 3, in which the main body 3 is electrically connected with the foldable connection plug 2 through the electrical connection wire 4.

Please refer to FIG. 1, 6. When the foldable connection plug 2 is housed in the accommodation room 101, the second end side 1322 of the push strip 132 is engaged in the first snap recess 25 when the compression spring 12 in the accommodation room 101 is in a compressed state. When exerting force on the press part 131 of the spring member 13, the second side end 1322 of the push strip 132 is driven away from the first snap recess 25, and the compression spring 133 of the spring member 13 is in a compressed state. Meanwhile, the compression spring 12 in the accommodation room 101 release the pre-pressure 'so that the foldable connection plug 2 bounces out the accommodation room 101. Releasing the press part 131 will get the second side end 1322 of the push strip 132 engaged in the second snap recess 261, and moving the fastener 231 to where is between the first connection part 21 and the second connection part 22 enables the first connection part 21 and the second connection part 22 not to be randomly crooked. The metal contacts 24 of the foldable connection plug 2 is electrically connected with an electronic component (not shown) being compatible with the USB transmission interface. The electronic component that is compatible with the USB transmission interface can be an EDI device, such as computer, digital camera, copy machine, mobile phone, and so forth.

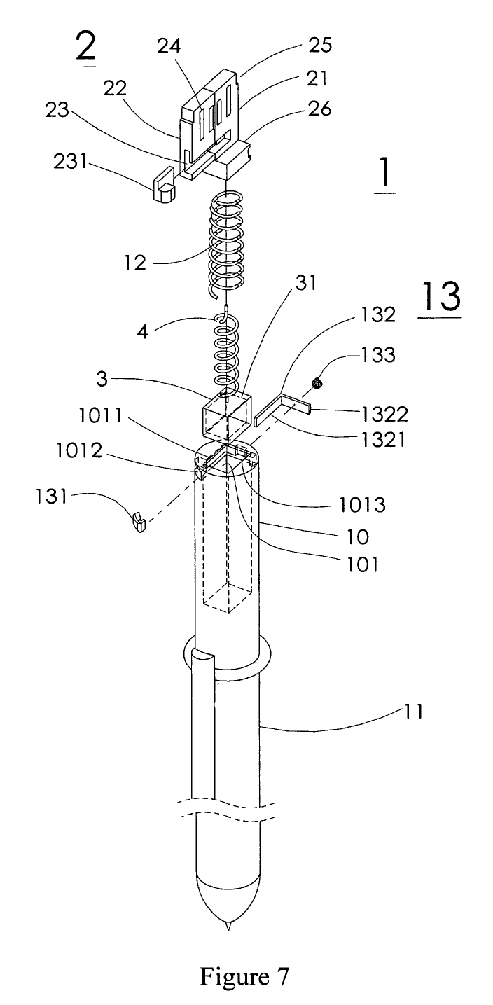

Please refer to FIG. 7, which shows the second preferred embodiment of the present invention and differs from the first preferred embodiment in that the upper penholder 10 and the lower penholder 11 are integrally formed. The rest of the embodiment is the same as that of the first preferred embodiment.

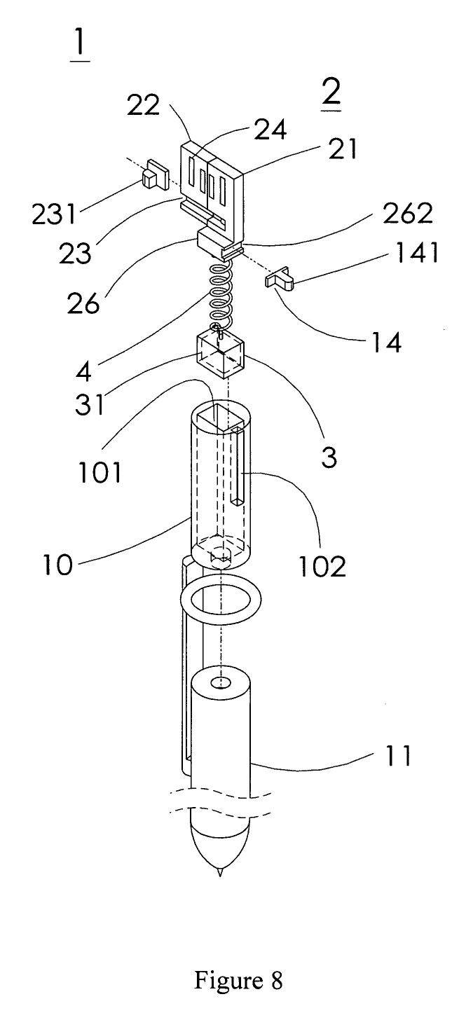

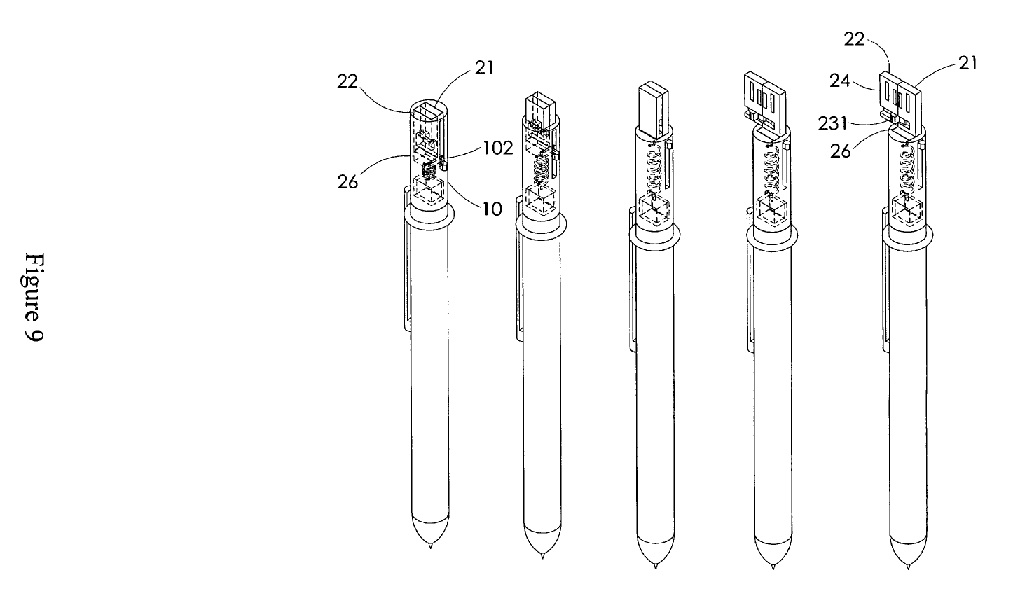

Please refer to FIG. 8, which shows the third preferred embodiment and is a pen featuring as a USB memory device. Similarly, the pen includes a penholder 1 having an upper penholder 10 and a lower penholder 11, in which the upper penholder 11 has a pen body, e.g. a refill case, and the upper penholder 10 and a lower penholder 11 can be detachably connected. The upper penholder 10 has an accommodation room 101 therein; one end of the accommodation room 101 communicates with an outer periphery of the upper penholder 10, and the outer diameter of the upper penholder is not greater than 12 mm.

Please refer to FIG. 8. A foldable connection plug 2 is housed in the accommodation room 101 of the upper penholder 10. The foldable connection plug 2 includes a support seat 26, at least a first connection part 21, and at least a second connection part 22, in which the foldable connection plug 2 has metal contacts 24 being compatible with a USB transmission interface, the metal contacts 24 are electrically connected with an electronic component with a USB transmission interface, the electronic component that is compatible with the USB transmission interface can be an EDI device, the support seat 26 has a recess 262, a movable seat is disposed on the recess 262, and the movable seat 14 has a push part 141; a main body 3 is housed in the accommodation room 101 of the upper penholder 10 and contains at least an electronic component 31.

Please refer to FIG. 8, 9. A slot hole 102 is provided on the periphery of the upper penholder 10 to correspond to the recess 262 of the foldable connection plug 2. The slot hole 102 penetrates through the inner wall and outer wall of the upper penholder 10, the push part 141 goes through the slot hole 102, and the outer end of the push part 141 is protruded beyond the outer periphery of the upper penholder 10.

Please further refer to FIG. 8, 9. The foldable connection plug 2 has at least a track 23 communicating with the opposite end faces of the first connection part 21 and the second connection part 22, in which a fastener 231 is disposed on the track 23. An electrical connection wire 4 is located between the support seat 26 and the main body 3, in which the main body 3 is electrically connected with the foldable connection plug 2 via the electrical connection wire 4.

Please further refer to FIG. 8, 9. When the foldable connection plug 2 is housed in the accommodation room 101, exert force on the push part 141 to move the push part 141 along the slot hole 102 so as to push the foldable connection plug 2 out of the accommodation room 101; move the fastener 231 to where is between the first connection part 21 and the second connection part 22 so that the first connection part 21 and the second connection part 22 won't be randomly crooked; electrically connect the metal contacts 24 of the foldable connection plug 2 with the electronic component (not shown) being compatible with a USB transmission interface, in which the electronic component (not shown) can be an EDI device, such as computer, digital camera, copy machine, mobile phone, and so forth.

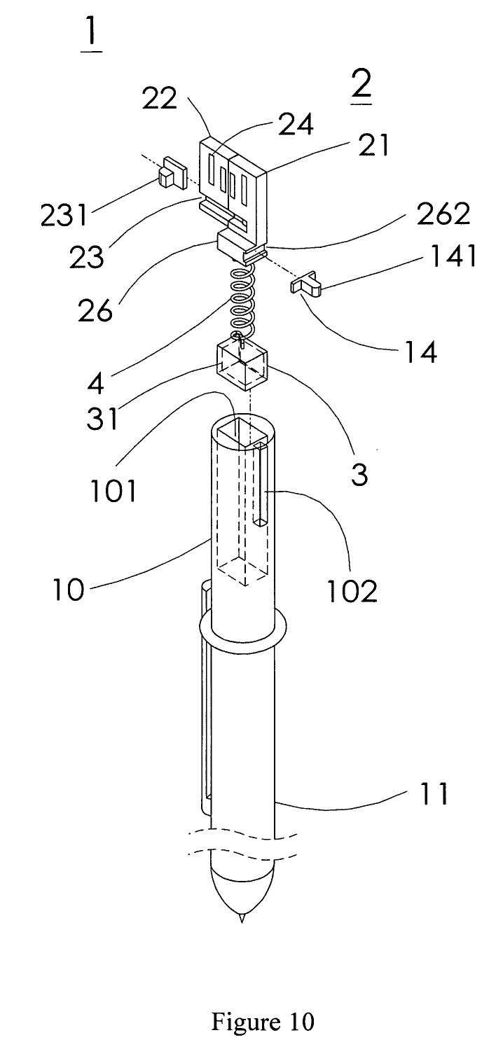

Please refer to FIG. 10, which shows the fourth preferred embodiment of the present invention and differs from the third preferred embodiment in that the upper penholder 10 and the lower penholder 11 are integrally formed. The rest of the embodiment is the same as that of the third preferred embodiment.

In sum, the present invention provides a pen featuring as a USB memory device, which allows the pen to maintain its original function in conveniently carrying and holding with ease, enable the memory itself to be advantageous to have a compact size by employing the miniaturization package technology, and house the foldable connection plug and the memory in the accommodation room by virtue of the folding feature of the foldable connection plug, so that the foldable memory can be easily received without being lost. As a consequence, the present invention has a combinational function.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A pen featuring as a USB memory device, comprising:
a penholder having an upper penholder and a lower penholder, wherein the upper penholder has an accommodation room therein, one end of the accommodation room communicates with an outer periphery of the upper penholder, at least a compression spring is disposed at the other end of the accommodation room, the upper penholder has at least a spring member, and the lower penholder is provided to house a pen body;
a foldable connection plug housed in the accommodation room of the upper penholder and having a support seat, at least a first connection part, at least a second connection part and a plurality of metal contacts being compatible with a USB transmission interface; and
a main body housed in the accommodation room of the upper penholder and having at least an electronic component.

2. The pen as claimed in claim 1, wherein the spring member comprises at least a press part, at least a push strip and at least a compression spring, the push strip has a first side end and a second side end, one end of the accommodation room communicates with an edge of the upper penholder, at least a passageway is provided on an outer periphery of the accommodation room, one end of the passageway communicates with an outer periphery of the upper penholder to form a notched hole and a cavity is disposed on the other end.

3. The pen as claimed in claim 2, wherein the press part is disposed on an outer periphery of the upper penholder to correspond to the notched hole, the push strip is housed in the passageway and the first side end of the push strip is combined with the press part, the compression spring is housed in the cavity of the passageway and is combined with the second side end of the push strip.

4. The pen as claimed in claim 2, wherein an end-to-end length of an outer periphery of the press part is not greater than an end-to-end length of an outer periphery of the notched hole.

5. The pen as claimed in claim 2, wherein an end-to-end length of the outer periphery of the push strip is not greater than an end-to-end length of an outer periphery of the passageway.

6. The pen as claimed in claim 2, wherein the height of the compression spring is not less than the height of the notched hole.

7. The pen as claimed in claim 2, wherein an end face of the foldable connection plug corresponding to the compression spring has a first snap recess.

8. The pen as claimed in claim 7, wherein an end face of the support seat opposite to the first snap recess has a second snap recess.

9. The pen as claimed in claim 7, wherein the upper penholder and the lower penholder are integrally formed.

10. The pen as claimed in claim 1, wherein the upper penholder and the lower penholder are detachably connected.

11. The pen as claimed in claim 1, wherein the metal contacts are electrically connected with an electronic component being compatible with a USB transmission interface, and the electronic component is an EDI device.

12. The pen as claimed in claim 1, wherein the foldable connection plug has at least a track communicating opposite end faces of the first connection part and the second connection part.

13. The pen as claimed in claim 12, wherein at least a fastener is disposed on the track.

14. The pen as claimed in claim 1, wherein the compression spring is located between the support seat and the main body.

15. The pen as claimed in claim 1, wherein the main body is electrically connected with the foldable connection plug via an electrical connection wire.

16. The pen as claimed in claim 1, wherein an outer diameter of the upper penholder is not greater than 12 mm.

17. A method for operating a pen featuring as a USB memory device, comprising the following steps of:
(1) when the foldable connection plug is housed in the accommodation room, engaging the second side end in the first snap recess so that the compression spring in the accommodation room is in a compressed state;
(2) exerting force on the push part of the spring member to push the second side end of the push strip out of the first snap recess while the compression spring of the spring member is in a compressed state;
(3) releasing the pre-pressure of the compression spring in the accommodation room to let the foldable connection plug bounce out of the accommodation room;
(4) loosening up the press part to engage the second side end of the push strip in the second snap recess;
(5) moving the fastener to where is between the first connection part and the second connection part so that the first connection part and the second connection part are not crooked; and
(6) electrically connecting the metal contacts of the foldable connection plug with a computer or an electronic component being compatible with a USB transmission interface.

18. A pen featuring as a USB memory device, comprising:
a penholder having an upper penholder and a lower penholder, wherein the upper penholder has an accommodation room therein, one end of the accommodation room communicates with an outer periphery of the upper penholder, and the lower penholder is provided to house a pen body;
a foldable connection plug housed in the accommodation room of the upper penholder, having a support seat, at least a first connection part, at least a second connection part and a plurality of metal contacts being compatible with a USB transmission interface, wherein the support seat has a recess, a movable seat is disposed on the recess, and the movable seat has a push part; and
a main body housed in the accommodation room of the upper penholder and having at least an electronic component.

19. The pen as claimed in claim 18, wherein a slot hole is provided on an outer periphery of the upper penholder to correspond to the recess of the foldable connection plug, the slot hole penetrates through the inner wall and outer wall of the upper penholder, the push part goes through the slot hole, and an outer end of the push part is protruded beyond the outer periphery of the upper penholder.

20. The pen as claimed in claim 18, wherein the upper penholder and the lower penholder are integrally formed.

21. The pen as claimed in claim 18, wherein the upper penholder and the lower penholder are detachably connected.

22. The pen as claimed in claim 18, wherein the metal contacts are electrically connected with the electronic component being compatible with the USB transmission interface, and the electronic component is an EDI device.

23. The pen as claimed in claim 18, wherein the foldable connection plug has at least a track, and the track communicates with opposite end faces of the first connection part and the second connection part.

24. The pen as claimed in claim 23, wherein at least a fastener is disposed on the track.

25. The pen as claimed in claim 18, wherein the main body is electrically connected with the foldable connection plug via an electrical connection wire.

26. The pen as claimed in claim 18, wherein an outer diameter of the upper penholder is not greater than 12 mm.

27. A method for operating a pen featuring as a USB memory device, comprising the following steps of:
(1) housing the foldable connection plug in the accommodation room;
(2) exerting force on the push part to move the push part along the slot hole so as to push the foldable connection plug out of the accommodation room;
(3) moving the fastener to where is between the first connection part and the second connection part so that the first connection part and the second connection part are not crooked; and
(4) electrically connecting the metal contacts of the foldable connection plug with a computer or an electronic component being compatible with a USB transmission interface.
